(19) United States
(12) Patent Application Publication
(10) Pub. No.: US 2006/0169879 A1
(43) Pub. Date: Aug. 3, 2006

(54) Optical rotation angle detecting device

(75) Inventor: Masatsugu Urakawa, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/340,153

(22) Filed: Jan. 25, 2006

(30) Foreign Application Priority Data
Feb. 2, 2005 (JP) 2005-026876

(51) Int. Cl. G01D 5/34

(52) U.S. Cl. 250/231.13

(57) ABSTRACT

Terminal insertion holes for allowing terminals of photo sensors (photo ICs and photo interrupters) to be respectively inserted therethrough are bored in a circuit board on which the photo sensors are to be mounted. Some of the terminal insertion holes regulate the corresponding terminals in the circumferential direction of the code plate so that each photo sensor is positioned in the circumferential direction. A holder fixedly positioned on the circuit board is provided with a reference surface and a projection that face each other along a radial direction of the code plate within each sensor holding hole, A main body of each photo sensor is fitted into each sensor holding hole so that each photo sensor is positioned in the radial direction.

### BACKGROUND OF THE INVENTION

1. Field of the Invention

The present invention relates to an optical rotation angle detecting device which is appropriate for detecting a steering angle of a vehicle-mounted steering wheel, etc.

2. Description of the Related Art

In order to detect a steering angle, etc. of a vehicle-mounted steering wheel, there is known an optical rotation angle detecting device according to the related art adapted to determine the rotational operation of a code plate by photo interrupters. Such an optical rotation angle detecting device according to the related art is configured such that a slit row consisting of light-shielding walls and slits is provided along the circumferential direction of the code plate that rotates in cooperation with the steering wheel, and when the code plate rotates, the slit row passes between a light-emitting part and a light-receiving part of a photo interrupter mounted on a circuit board. Accordingly, on the basis of signals of the light that has reached the light-receiving parts from the light-emitting parts, the rotation angle, rotational direction, etc. of the code plate can be detected (for example, JP-A-2003-287418 (pages 3 to 4 and FIG. 1)). In addition, this type of optical angle detecting device is used to control transmissions of automobiles, control steering of rear wheels of four-wheel steering vehicles, and the like. In recent years, miniaturizing the device and enhancing the performance of the device have been increasingly demanded.

Meanwhile, miniaturizing this type of optical rotation angle detecting device and enhancing the performance thereof require photo sensors, such as photo interrupters, to be mounted on a circuit board with high positional precision. In particular, since any positional deviation of the photo sensors along the circumferential direction of the code plate is directly linked to errors in detected positions, as the device is made smaller, the detection precision of the rotation angle easily deteriorates. However, the above-mentioned optical rotation angle detecting device according to the related art adopts an ordinary mounting structure in which terminals of each photo sensor are loosely inserted into terminal insertion holes, respectively, of the circuit board and are then soldered to lands. Thus, the photo sensor slightly deviates within the mounting surface, and consequently, if miniaturization of the device is promoted, it is gradually difficult to obtain a desired detection precision.

### SUMMARY OF THE INVENTION

The invention has been finalized in view of the drawbacks inherent in the conventional optical rotation angle detecting device, and it is an object of the invention to provide an optical rotation angle detecting device having a photo sensor with a high positional precision and capable of easily ensuring a desired detection precision in a small size.

In order to achieve the above object, according to one aspect of the invention, there is provided an optical rotation angle detecting device including a photo sensor having a plurality of terminals protruding from a main body composed of a light-emitting part and a light-receiving part opposed to each other; a circuit board having a plurality of terminal insertion holes through which the terminals are to be inserted, respectively, and on which the photo sensor is to be mounted; a holder having a sensor holding hole into which the main body of the photo sensor is to be fitted, and fixedly positioned on the circuit board; and a rotatable code plate having a slit row to pass between the light-emitting part and the light-receiving part provided along its circumferential direction. The holder is provided with a reference surface and a projection that face each other along a radial direction of the code plate within the sensor holding hole. The main body is fitted between the reference surface and the projection so that the photo sensor is positioned in the radial direction of the code plate. Some of the plurality of terminal insertion holes regulate the positions of the corresponding terminals in the circumferential direction of the code plate so that the photo sensor is positioned in the circumferential direction.

In the optical rotation angle detecting device configured as such, if predetermined terminals are inserted into the corresponding terminal insertion holes of the circuit board during assembly, the terminal insertion holes regulate the position of the terminals so that the photo sensor is positioned along the circumferential direction of the code plate. Therefore, any positional deviation of the photo sensor along the circumferential direction, which is particularly important, can be easily avoided, as well as the detection precision can be ensured. Further, when the main body of the photo sensor is press-fitted into the sensor holding hole of the holder fixedly positioned on the circuit board, the photo sensor is positioned along the radial direction of the code plate, and the photo sensor is held by the holder. Therefore, the assembling performance of the device is also excellent.

In the above configuration, if, among two of the terminal insertion holes juxtaposed along the circumferential direction of the code plate, one terminal insertion hole is formed in a position that regulates movement of the corresponding terminal to one side in the circumferential direction, and the other terminal insertion hole is formed in a position that regulates movement of the corresponding terminal to the other side in the circumferential direction, the attachment position of the photo sensor along the circumferential direction can be specified with high precision by inserting the terminals into the two corresponding terminal insertion holes. In this case, if the spacing between two of the terminal insertion holes is set to be approximately equal to the spacing between two of the terminals to be inserted through the two terminal insertion holes, respectively, the photo sensor can be positioned as well as the spacing between both the terminals can be ensured to a maximum extent. Therefore, even if the photo sensor has a narrow pitch between the terminals, a distance commensurate with the spacing can be ensured between both the lands on the side of circuit board, which is preferable. For example, in a case where the photo sensor is a photo IC having three terminals protruding in a row from the light-receiving part, the spacing between two of the terminal insertion holes through which two terminals at both ends among the three terminals are to be inserted, respectively, may be set to be approximately equal to the spacing between the two terminals.

Further, in the above configuration, if the inner diameter of a predetermined one of the terminal insertion holes along the circumferential direction is set to be approximately equal to the width of the corresponding terminal along the circumferential direction so that the predetermined terminal insertion hole regulates movement of the corresponding terminal in the circumferential direction, the attachment position of the photo sensor along the circumferential direction can be specified with high precision by inserting the terminal into the terminal insertion hole. For example, in a case in which the photo sensor is a photo IC having three terminals protruding in a row from the light-receiving part, the inner diameter, along the circumferential direction, of the terminal insertion hole through which the central terminal among the three terminals is to be inserted may be set to be approximately equal to the width of the central terminal along the circumferential direction. In general, since an amplifying circuit is built in a light-receiving part of a photo IC, a total of three terminals, i.e., an output terminal connected to the output side of a transistor, a minus terminal connected to the ground side, and a plus terminal provided via a constant-voltage circuit to be built in are provided.

In the optical rotation angle detecting device of the invention, during assembly, the position of the terminals of the photo sensor is regulated by the terminal insertion holes on the circuit board so that the photo sensor is positioned along the circumferential direction of the code plate. Therefore, any positional deviation of the photo sensor along the circumferential direction, which is particularly important, can be easily avoided, as well as the detection precision can be ensured. Further, the main body of the photo sensor is press-fitted into the sensor holding hole of the holder fixedly positioned on the circuit board so that the photo sensor is positioned along the radial direction of the code plate, and the photo sensor is held by the holder. Therefore, the assembling performance of the device is also excellent. Accordingly, it is possible to obtain an optical rotation angle detecting device capable of easily ensuring a desired detection precision in a small size and having excellent assembling performance.

### BRIEF DESCRIPTION OF THE DRAWINGS

FIG. 1 is an exploded perspective view of an optical rotation angle detecting device according to a first embodiment of the invention;

FIG. 2 is a partial sectional view of the optical rotation angle detecting device;

FIG. 3 is an enlarged view of a photo IC provided in the optical rotation angle detecting device;

FIG. 4 illustrates the attachment structure of the photo IC;

FIG. 5 illustrates a state in which terminals of the photo IC are positioned;

FIG. 6 illustrates a portion of a circuit board provided in the optical rotation angle detecting device;

FIG. 7 is a partially enlarged view of FIG. 6; and

FIG. 8 illustrates a state in which terminals of a photo IC in a second embodiment of the invention are positioned.

### DESCRIPTION OF THE PREFERRED EMBODIMENT

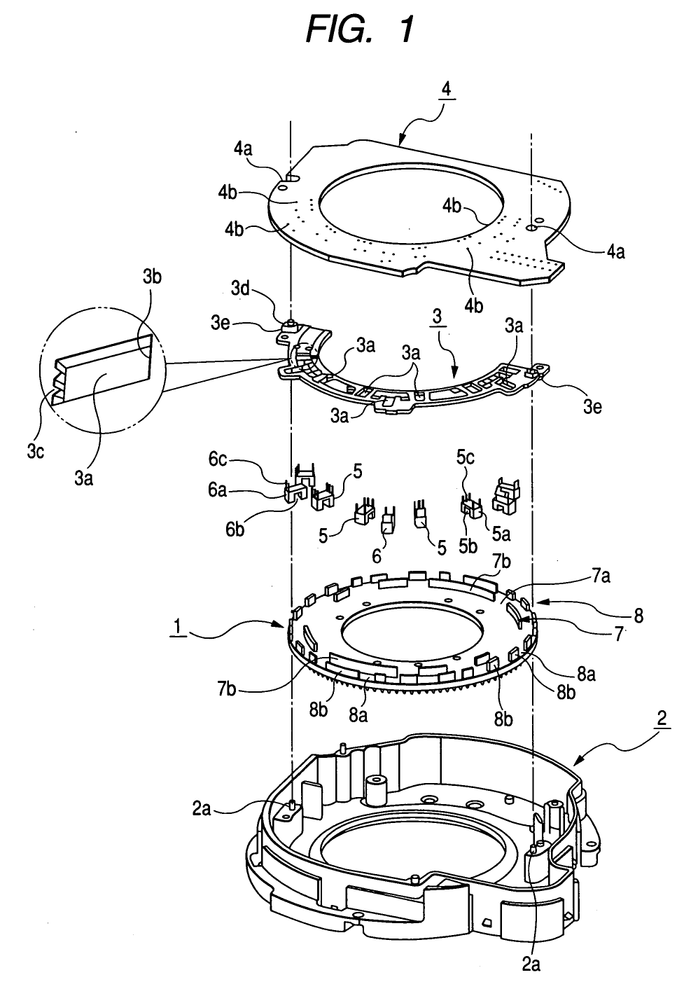

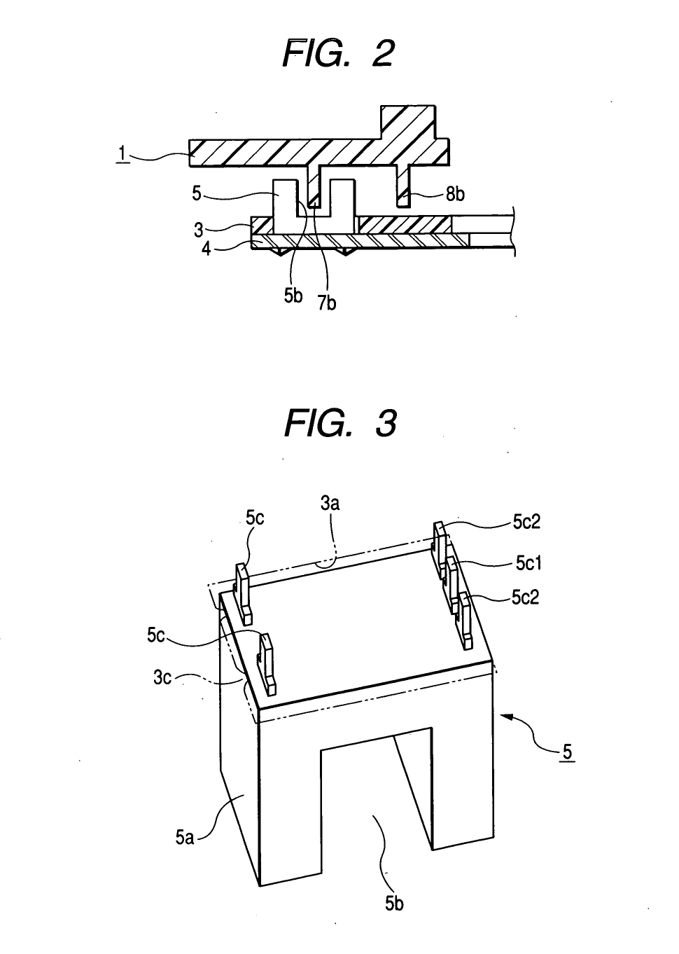

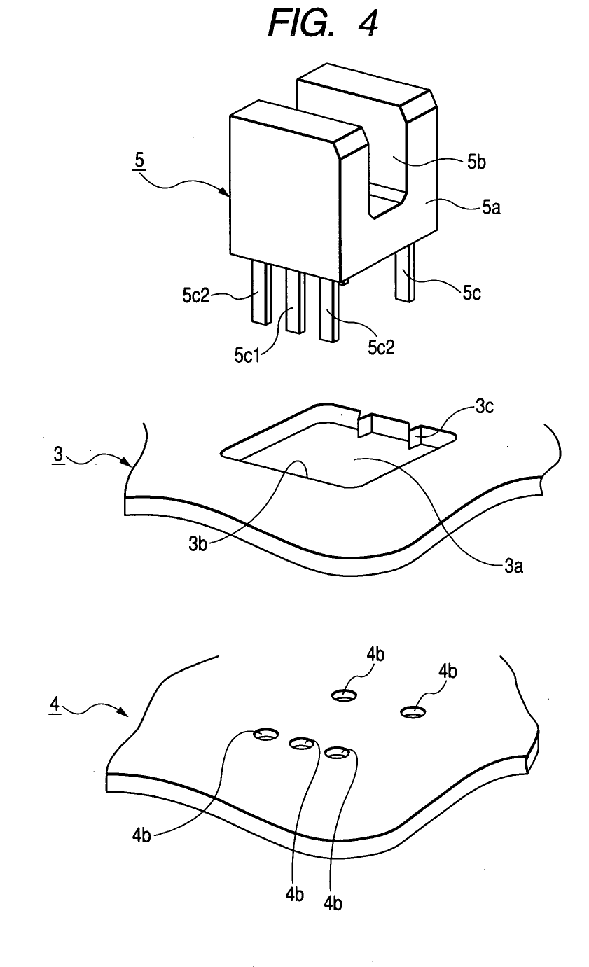

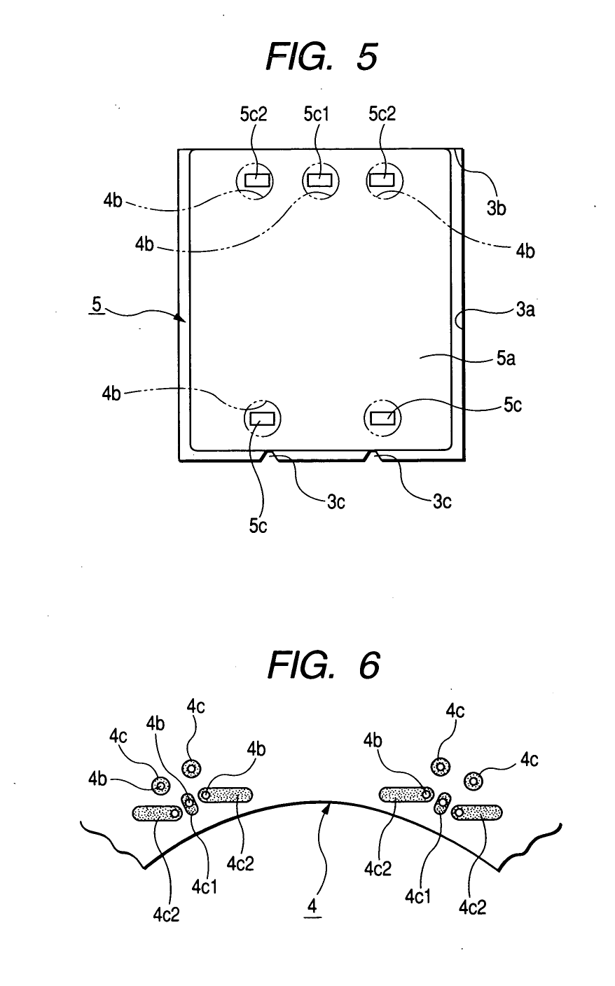

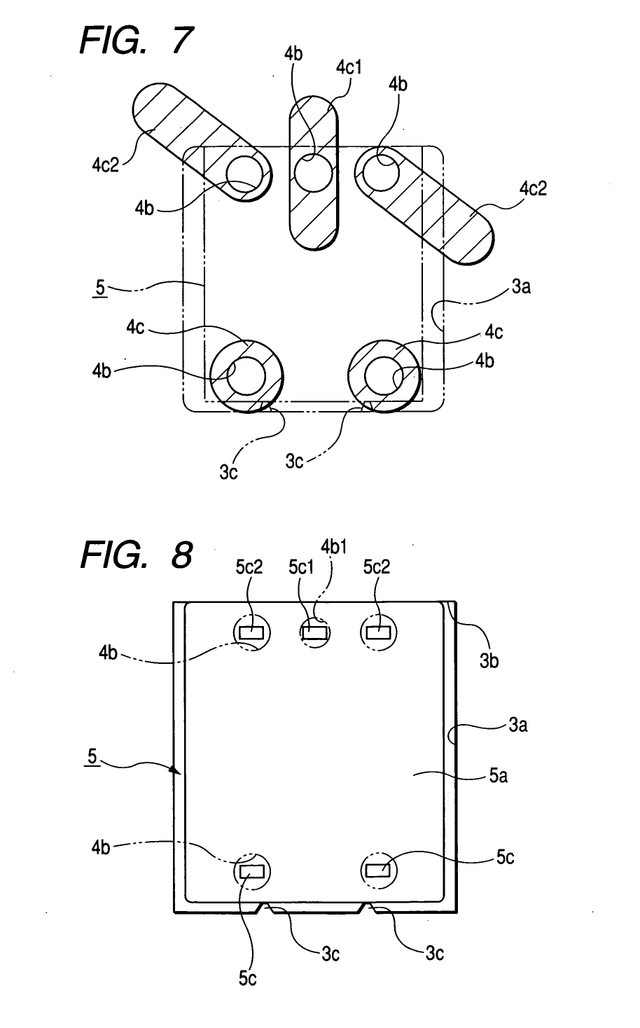

Hereinafter, preferred embodiments of the invention will be described with reference to the accompanying drawings. FIG. 1 is an exploded perspective view of an optical rotation angle detecting device according to a first embodiment of the invention, FIG. 2 is a partial sectional view of the optical rotation angle detecting device, FIG. 3 is an enlarged view of a photo IC provided in the optical rotation angle detecting device, FIG. 4 illustrates the attachment structure of the photo IC, FIG. 5 illustrates a state in which terminals of the photo IC are positioned, FIG. 6 illustrates a portion of a circuit board provided in the optical rotation angle detecting device, and FIG. 7 is a partially enlarged view of FIG. 6.

The optical rotation angle detecting device shown in FIG. 1 is built in a vehicle-mounted steering apparatus so as to be used to detect a steering angle, etc. of a steering wheel. A rotary body (not shown) connected to the steering wheel is integrally provided with a code plate 1 such that a steering shaft (not shown) passes through a central hole of the code plate 1. An outer case 2 is fixed to a stator member (not shown) of the steering apparatus, and a holder 3 and a circuit board 4 are fixedly positioned in the outer case 2. A plurality of photo-sensors (photo ICs 5 and photo-interrupters 6) are mounted on the circuit board 4, and a main body (5a, 6a) of each photo sensor in which a light-receiving part and a light-emitting part are opposed to each other with a recess (5b, 6b) therebetween is fitted into a sensor holding hole 3a of each holder 3.

An inside slit row 7 consisting of slits 7a and light-shielding walls 7b and an outside slit row 8 consisting of slits 8a and light-shielding walls 8b are respectively provided concentrically along a circumferential direction in the code plate 1. The two slit rows 7 and 8 function as tracks to output gray codes for detecting an absolute angle.

Among the plurality of photo sensors, the group of photo ICs 5 is disposed in a position facing the inside slit row 7, and the group of photo interrupters 6 is disposed in a position facing the outside slit row 8. In other words, when the code plate 1 rotates, the inside slit row 7 passes through the recess 5b of the main body 5a of each photo IC 5, and the outside slit row 8 passes through the recess 6b of the main body 6a of each photo interrupter 6. In addition, the main body 5a, 6a of each photo sensor is a module package having a rectangular shape in plan view, the photo IC 5 has five terminals 5c protruding from the main body 5a (two terminals protruding from the light-emitting part and three terminals protruding from the light-receiving part), and the photo interrupter 6 has four terminals 6c protruding from the main body 6a (two terminals protruding from the light-emitting part and two terminals protruding from the light-receiving part).

The holder 3 is a circular arc plate-shaped molded product along a direction in which the group of photo ICs 5 and the group of photo interrupters 6 are arrayed. A plurality of sensor holding holes 3a for allowing the main body 5a, 6a of each photo sensor to be fitted thereinto are bored through the holder 3. As shown in an enlarged view of FIG. 1, each sensor holding hole 3a is provided with a reference surface 3b and a projection 3c opposite to each other along the radial direction of the code plate 1. The main body 5a or the main body 6a is press-fitted between the reference surface 3b and the projection 3c, so that each photo sensor (photo IC 5 or photo interrupter 6) can be positioned in the radial direction of the code plate 1. Specifically, as shown in FIGS. 3 and 4, when the main body 5a of the photo IC 5 (or the main body 6a of the photo interrupter 6) is press-fitted into the sensor holding hole 3a, the tip of the projection 3c is crushed and the main body 5a (or 6a) is pressed against the reference surface 3b. Thus, the photo IC (or the photo interrupter 6) is held by the holder 3 while it is positioned in the radial direction. Also, bosses 3e each having a fitting hole 3d protrude from both ends of the holder 3. The bosses 3e are fitted into corresponding holes 4a of the circuit board 4, so that the holder 3 can be positioned with respect to the circuit board 4, and positioning protrusions 2a of the outer case 2 are fitted into the corresponding fitting holes 3d of the bosses 3e, so that the holder 3 and the circuit board 4 can be positioned with respect to the outer case 2.

A plurality of terminal insertion holes 4b for allowing the terminals 5c, 6c of the photo sensors to be respectively inserted therethrough are bored in the circuit board 4 and a plurality of lands 4c for allowing the terminal insertion holes 4b to be exposed are also disposed on the circuit board. The terminals 5c or terminals 6c inserted through the terminal insertion holes 4b are soldered to the lands 4c by dip soldering, so that the photo ICs 5 and the photo interrupters 6 are mounted on the circuit board 4. As shown in FIG. 5, the two terminals 5c protruding from the light-emitting part of the photo IC 5 and the middle terminal 5c₁ of the three terminals protruding in a row from the light-receiving part are loosely inserted the corresponding terminal insertion holes 4b. However, the remaining two terminals 5c₂ of the photo IC 5 are restrained from being moved toward the middle terminal 5c₁ when they are inserted through the corresponding terminal insertion holes 4b. This is because the spacing between the two terminal insertion holes 4b corresponding to the two terminals 5c₂ is set to be approximately equal to the spacing between both the terminals 5c₂. By doing so, during assembly, the photo IC 5 can be positioned in the circumferential direction of the code plate 1, and the spacing between the terminal insertion hole 4b for the terminal 5c₁ and the terminal insertion holes 4b of for the terminals 5c₂ can be ensured. Similarly, the two terminals 6c protruding from the light-emitting part or light-receiving part of the photo interrupter 6 are loosely inserted the corresponding terminal insertion holes 4b. However, the remaining two terminals 6c are restrained from moving nearer to or away from each other when they are inserted into the corresponding terminal insertion holes 4b, so that the photo interrupter 6 can be positioned in the circumferential direction of the code plate 1.

As shown in FIGS. 6 and 7, among the plurality of lands 4c formed on the circuit board 4, three lands 4c₁ and 4c₂ for soldering the three terminals 5c₁ and 5c₂ protruding in a row from the light-receiving part of the photo IC 5 are formed in an elongated shape. In other words, the land 4c₁ to which the middle terminal 5c₁ among the three terminals is to be soldered is formed in an elongated shape extending along the radial direction of the code plate 1. The two lands 4c₂ to which the terminals 5c₂ at both ends are to be soldered are formed in an elongated shape extending in the direction in which they gets away from each other while the corresponding terminal insertion holes 4b are exposed at the one ends of the lands. The extending direction are made consistent with the direction in which the circuit board 4 moves during a dip soldering process.

In the optical rotation angle detecting device configured as above, when the code plate 1 integrated in the steering wheel rotates, the inside slit row 7 passes through the recess 5b of each photo IC 5, and the outside slit row 8 passes through the recess 6b of each photo interrupter 6. Thus, the light emitted from the light-emitting part of the photo IC 5 passes through the slit 7a and is received by the light-receiving part, and the light emitted from the light-emitting part of the photo interrupter 6 passes through the slit 8a and is received by the light-receiving part. Accordingly, on the basis of signals of the light that has reached the light-receiving part from the light-emitting part of the photo sensor, the rotation angle and rotation direction of the code plate 1 are detected by a control unit (not shown) mounted on the circuit board 4.

As such, in the optical rotation angle detecting device according to this embodiment, when the two terminals 5c₂ of the photo IC 5 are inserted into the corresponding two terminal insertion holes 4b during assembly, the photo IC 5 is positioned along the circumferential direction of the code plate 1 by both the terminal insertion holes 4b. Therefore, any positional deviation of the photo IC 5 along the circumferential direction, which is particularly important, can be easily avoided as well as the detection precision can be ensured. Similarly, since the position of the two terminals 6c of the photo interrupter 6 are also regulated in the corresponding two terminal insertion holes 4b, any positional deviation of the photo interrupter 6 along the circumferential direction of the code plate 1 can be easily avoided. Accordingly, even if the optical rotation angle detection device is made small, a desired detection precision can be easily ensured. Further, while the main body Sa or the main body 6a is press-fitted into each sensor holding hole 3a of the holder 3 positioned on and fixed to the circuit board 4, the photo IC 5 or the photo interrupter 6 is positioned along the radial direction of the code plate 1, and the photo IC 5 or the photo interrupter 6 is held by the holder 3. Therefore, the assembling performance of the optical rotation angle detecting device is also excellent.

Further, in the optical rotation angle detecting device, the two lands 4c₂ for soldering the terminals 5c₂ at both ends among the three terminals with small pitch protruding from the light-receiving part of the photo IC 5, are formed in an elongated shape extending in the direction in which they get away from the exposed one ends of the terminal insertion holes 4b. Therefore, even if the area needed for both the lands 4c₂ is ensured, the lands 4c₂ do not approach the middle land 4c₁. Also, the extending direction of both the lands 4c₂ is made consistent with the direction in which the circuit board 4 moves during a dip soldering process. Therefore, the solder to be adhered onto both the lands 4c₂ is thickest in the middle portion (longitudinal middle portion) in the extending direction, which is sufficiently away from the middle land 4c₁. Consequently, a solder bridge is hardly generated between both the lands 4c₂ and the middle land 4c₁ that are obliged to be arranged close to each other. Moreover, in this embodiment, the middle land 4c₁, is formed in an elongated shape extending along the radial direction of the code plate 1, whereby the middle land 4c₁ is made orthogonal to a straight line that connects the terminal insertion holes 4b exposed to both the lands 4c₂, and the spacing between the terminal insertion holes 4b exposed to both the lands 4c₂ is set be wide in order to restrain the positions of both the terminals 5c₂. Thus, a distance commensurate with the spacing is ensured between both the lands 4c₂ and the middle land 4c₁. From this viewpoint, the possibility that a solder bridge may be generated between the lands 4c₁ and 4c₂ is low. Hence, the production yield of the optical rotation angle detecting device is high.

FIG. 8 illustrates a state in which terminals of a photo IC in a second embodiment of the invention are positioned. In this figure, the portions corresponding to those in FIG. 5 are denoted by the same reference numerals and the duplicated description thereof is omitted.

The second embodiment is different from the above first embodiment in that, in order to position the photo IC 5 along the circumferential direction of the code plate 1, the middle terminal 5c₁ among the three terminals protruding from the light-receiving part of the photo IC 5 is restrained in position in the circumferential direction by the terminal insertion holes 4b₁ having a small diameter. Specifically, as shown in FIG. 8, the terminal insertion hole 4b₁ through which the middle terminal 5c₁ is to be inserted is made slightly smaller than the other terminal insertion holes 4b, and the inner diameter of the terminal insertion hole 4b₁ is set to be approximately equal to the width of the terminal 5c₁ along the circumferential direction of the code plate 1. Therefore, when the terminal 5c₁ is inserted into the terminal insertion hole 4b₁ during assembly, the photo IC 5 is positioned along the circumferential direction. At that time, the main body of the photo IC 5 is press-fitted into the sensor holding hole 3a of the holder fixedly positioned on the circuit board so as to be positioned in the radial direction of the code plate 1. Therefore, the attachment position of the photo IC 5 can be set with high precision simply by restraining the position of the one terminal 5c₁ along the circumferential direction of the code plate 1. Further, when the diameter of the terminal insertion hole 4b₁ through which the middle terminal 5c₁ among the three terminals with such small pitch is to be inserted is made small, the land that is allowed to expose the terminal insertion hole 4b₁ can be made narrow. Therefore, the distance between the above land and two lands to which the terminals 5c₂ at both ends are to be soldered increases, and thereby a solder bridge is hardly generated between the lands.

1. An optical rotation angle detecting device comprising:
a photo sensor having a plurality of terminals protruding from a main body composed of a light-emitting part and a light-receiving part opposed to each other;
a circuit board having a plurality of terminal insertion holes through which the terminals are to be inserted, respectively, and on which the photo sensor is to be mounted;
a holder having a sensor holding hole into which the main body of the photo sensor is to be fitted, and fixedly positioned on the circuit board; and
a rotatable code plate having a slit row to pass between the light-omitting part and the light-receiving part provided along circumferential direction of the rotatable code plate,
wherein the holder is provided with a reference surface and a projection that face each other along a radial direction of the code plate within the sensor holding hole, and
wherein the main body is fitted between the reference surface and the projection so that the photo sensor is positioned in the radial direction of the code plate, and some of the plurality of terminal insertion holes regulate the positions of the corresponding terminals in the circumferential direction of the code plate so that the photo sensor is positioned in the circumferential direction.

2. The optical rotation angle detecting device according to claim 1,
wherein, among two of the terminal insertion holes juxtaposed along the circumferential direction of the code plate, one terminal insertion hole is formed in a position that regulates movement of the corresponding terminal to one side in the circumferential direction, and the other terminal insertion hole is formed in a position that regulates movement of the corresponding terminal to the other side in the circumferential direction.

3. The optical rotation angle detecting device according to claim 2,
wherein the spacing between two of the terminal insertion holes is set to be approximately equal to the spacing between two of the terminals to be inserted through the two terminal insertion holes respectively.

4. The optical rotation angle detecting device according to claim 3,
wherein the photo sensor is a photo IC having three terminals protruding in a row on the light-receiving part, and the spacing between two of the terminal insertion holes through which two terminals at both ends among the three terminals are to be inserted, respectively, is set to be approximately equal to the spacing between the two terminals.

5. The optical rotation angle detecting device according to claim 1,
wherein the inner diameter of a predetermined one of the terminal insertion holes along the circumferential direction is set to be approximately equal to the width of the corresponding terminal along the circumferential direction so that the predetermined terminal insertion hole regulates movement of the corresponding terminal in the circumferential direction.

6. The optical rotation angle detecting device according to claim 5,
wherein the photo sensor is a photo IC having three terminals protruding in a row from the light-receiving part, and the inner diameter, along the circumferential direction, of the terminal insertion hole through which the central terminal among the three terminals is to be inserted is set to be approximately equal to the width of the central terminal along the circumferential direction.
